(19) United States
(12) Patent Application Publication
(10) Pub. No.: US 2018/0120443 A1
(43) Pub. Date: May 3, 2018

(54) METHOD AND APPARATUS FOR REDUCING TIME UNCERTAINTY USING RELATIVE CHANGE IN POSITION

(71) Applicant: QUALCOMM Incorporated, San Diego, CA (US)

(72) Inventors: Prabhu Kandasamy, San Diego, CA (US); William Morrison, San Francisco, CA (US); Harisrinivas Chandrasekar, San Diego, CA (US); Manish Kushwaha, San Jose, CA (US)

(21) Appl. No.: 15/338,222

(22) Filed: Oct. 28, 2016

(51) Int. Cl. G01S 19/23; G01S 19/47; G01S 19/51

(52) U.S. Cl. CPC G01S 19/235; G01S 19/51; G01S 19/47

(57) ABSTRACT

A mobile device is capable of accurately maintaining a global time based on Satellite Position System (SPS) time decoded from an SPS signal using a clock signal acquired from a wireless communication transmitter, such as a base station or access point. The time uncertainty is reduced or minimized by determining a relative change in position of the mobile device with respect to a base position, e.g., a reference position determined from a previous SPS session. The time uncertainty may be determined based on the relative change in position with respect to the base position by transforming it into time units based on the speed of light. The global time may be updated based on the determined time uncertainty, which may be used in a subsequent SPS session to reduce the search window to acquire SPS satellite signals.

### BACKGROUND

### Background Field

The subject matter disclosed herein relates to wireless communications systems, and more particularly to methods and apparatuses for position location of a mobile device in a wireless communications system.

### Relevant Background

Global Navigation Satellite System (GNSS) receivers have been incorporated into a multitude of devices, including mobile devices such as mobile phones, tablet computers, satellite navigation systems, and other portable devices. GNSS receivers are used for determining a position of a mobile device by measuring the amount of time it takes for signals transmitted from satellites in the GNSS system to reach the GNSS receiver. The amount of time it takes a signal to arrive is a measure of the distance to the GNSS satellites. By measuring the distance to multiple GNSS satellites, e.g., four or more satellites, having known positions, the global position of the GNSS receiver may be determined.

When initiating a positioning session, the signals from the GNSS satellites are acquired through a search process. One factor that effects the acquisition of GNSS satellite signals is the satellite time information. The search space for satellite acquisition may be reduced if GNSS receiver uses a clock signal that is accurately synchronized with the clock signal used by the GNSS satellites. With a large time uncertainty, however, the GNSS receiver will be required to perform more or longer searches for the satellite signals. Multiple or long searches for satellites require additional power consumption, which may have a significant impact on battery life in a mobile device. Accordingly, for GNSS positioning, as well as other possible applications, it is desirable to reduce or minimize time uncertainty.

### SUMMARY

A mobile device is capable of accurately maintaining a global time based on Satellite Position System (SPS) time decoded from an SPS signal using a clock signal acquired from a wireless communication transmitter, such as a base station or access point. The time uncertainty is reduced or minimized by determining a relative change in position of the mobile device with respect to a base position, e.g., a reference position determined from a previous SPS session. The time uncertainty may be determined based on the relative change in position with respect to the base position by transforming it into time units based on the speed of light. The global time may be updated based on the determined time uncertainty, which may be used in a subsequent SPS session to reduce the search window to acquire SPS satellite signals.

In one implementation, a method of determining a time uncertainty includes determining a first position for a mobile device from a first Satellite Position System (SPS) session, wherein an SPS time is obtained during the first SPS session and set as global time; determining a relative change in position of the mobile device with respect to the first position; determining the time uncertainty based on the relative change in position; and updating the global time based on the time uncertainty.

In one implementation, a mobile device for determining a time uncertainty includes a Satellite Position System (SPS) receiver configured to receive signals from satellites in an SPS system; at least one inertial sensor; and at least one processor coupled to the SPS receiver and the at least one inertial sensor, the at least one processor configured to determine a first position for the mobile device from received signals from satellites during a first SPS session, wherein an SPS time is obtained during the first SPS session and set as a global time; determine a relative change in position of the mobile device with respect to the first position based on signals from the at least one inertial sensor; determine the time uncertainty based on the relative change in position; and update the global time based on the time uncertainty.

In one implementation, a mobile device for determining a time uncertainty includes means for determining a first position for the mobile device from a first Satellite Position System (SPS) session, wherein an SPS time is obtained during the first SPS session and set as global time; means for determining a relative change in position of the mobile device with respect to the first position; means for determining the time uncertainty based on the relative change in position; and means for updating the global time based on the time uncertainty.

In one implementation, a non-transitory computer-readable medium for determining a time uncertainty, the non-transitory computer-readable medium including program code stored thereon, includes program code to determine a first position for a mobile device from a first Satellite Position System (SPS) session, wherein an SPS time is obtained during the first SPS session and set as global time; program code to determine a relative change in position of the mobile device with respect to the first position; program code to determine the time uncertainty based on the relative change in position; and program code to update the global time based on the time uncertainty.

### BRIEF DESCRIPTION OF THE DRAWING

Non-limiting and non-exhaustive aspects are described with reference to the following figures, wherein like reference numerals refer to like parts throughout the various figures unless otherwise specified.

FIG. 1 is a simplified diagram illustrating a wireless communication system including mobile device capable of determining time uncertainty based on relative changes in position.

FIGS. 2A and 2B are flow charts illustrating methods of determining time uncertainty based on a relative change in position.

FIG. 3 illustrates a static example of determining time uncertainty based on a relative change in position.

FIG. 4 is a graph illustrating the growth of time uncertainty in the static example illustrated in FIG. 3.

FIG. 5 illustrates a dynamic example of determining time uncertainty based on a relative change in position.

FIG. 6 is a graph illustrating the growth of time uncertainty in the dynamic example illustrated in FIG. 5.

FIG. 7 is a block diagram of the mobile device capable of determining a time uncertainty based on a relative change in position.

### DETAILED DESCRIPTION

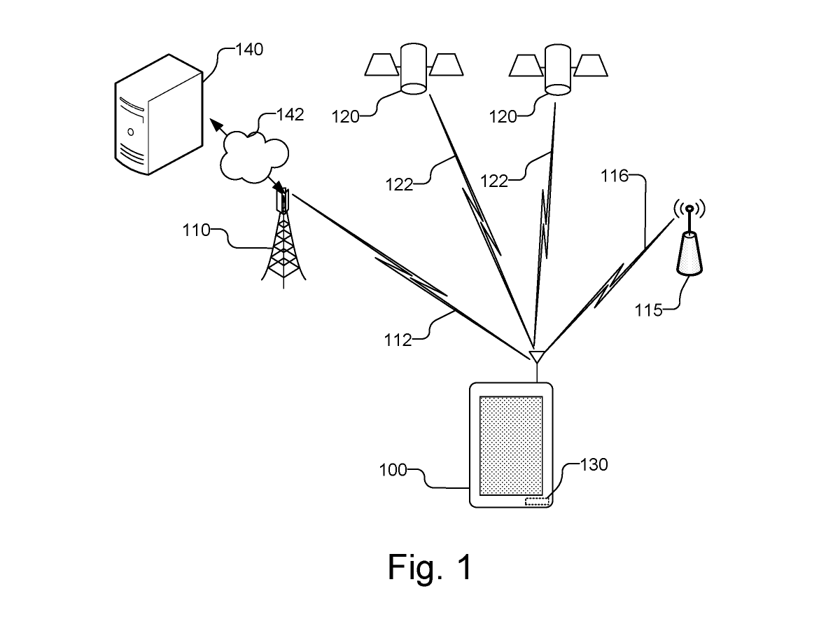

FIG. 1 is a simplified diagram illustrating a wireless communication system in which mobile device 100 is capable of wireless communication with one or more wireless communication transmitters 110, 115, as illustrated by links 112 and 116. As illustrated in FIG. 1, wireless communication point 110 may be a base station that may be part of a wide area network (WAN), such as a cellular communication network, and is therefore sometimes referred to herein as base station 110. The wireless communication point 115 may be an access point 115 that may be part of a local area network (LAN), and is therefore sometimes referred to herein as access point 110. The mobile device 100 further includes circuitry and processing resources capable of obtaining location related measurements from signals 122 received from Satellite Positioning System (SPS) satellites 120. The SPS positioning may be performed using measurements of signals 122 received from satellites 120 belonging to a Global Navigation Satellite System (GNSS) including Global Positioning System (GPS), Galileo, GLONASS or COMPASS or a non-global system, such as QZSS.

The mobile device 100 is capable of wireless communications, e.g., over a WAN and/or LAN network. For example, the access point 115 may be part of a LAN network and may be, e.g., a router, a bridge, etc. serving a Wi-Fi or IEEE 802.11 network, or may be, e.g., a femtocell or microcell. The base station 110, may be part of a WAN network, such as a cellular communication network and, may be, e.g., a wireless base transceiver subsystem (BTS), a Node B or an evolved NodeB (eNodeB). Examples of network technologies that may supported by base station 110 may be Global System for Mobile Communications (GSM), Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by an HNB. Base station 110 may comprise a deployment of equipment providing subscriber access to a wireless telecommunication network for a service (e.g., under a service contract). Here, a base station 110 may perform functions of a cellular base station in servicing subscriber devices within a cell determined based, at least in part, on a range at which the base station 110 is capable of providing access service. Of course it should be understood that these are merely examples of networks that may communicate with a mobile device 100, and claimed subject matter is not limited in this respect.

The mobile device 100 may additionally include sensors 130, such as inertial or motion sensors, such as a accelerometers, gyroscopes, electronic compass, magnetometer, camera, etc. that may be used to determine a changes in the relative position of the mobile device 100. For example, data from sensors 130 may be used determine a distance traveled or displacement from a position fix obtained using SPS satellites 120.

In some embodiments, the mobile device may obtain location related measurements from wireless communication transmitters, such as base station 110 or access point 115 or other types of terrestrial transmitters. For example, mobile device 100 or a separate location server 140, which may be accessed through a wireless communication link 142, may determine a location estimate for mobile device 100 based on these location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at mobile device 100 relative to three or more terrestrial transmitters or relative to four or more satellites with accurately known orbital data, or combinations thereof, based at least in part, on pilots, positioning reference signals (PRS) or other positioning related signals transmitted by the transmitters or satellites and received at mobile device 100. Mobile device 100 may be capable of receiving positioning assistance data from one or more servers 140, which may include information regarding signals to be measured (e.g., signal timing), locations and identities of terrestrial transmitters and/or signal, timing and orbital information for SPS satellites to facilitate positioning techniques such as A-GNSS, AFLT, OTDOA and E-CID. For example, server 140 may comprise an almanac which indicates locations and identities of cellular transceivers and/or local transceivers in a particular region or regions such as a particular venue, and may provide information descriptive of signals transmitted by a cellular base station or access point such as transmission power and signal timing. In the case of E-CID, a mobile device 100 may obtain measurements of received signal strengths (RSSI) for signals from base station 110 and/or access point 115 and/or may obtain a round trip signal propagation time (RTT) between mobile device 100 and a base station 110 or access point 115. A mobile device 100 may use these measurements together with assistance data (e.g. terrestrial almanac data or SPS satellite data such as GNSS Almanac and/or GNSS Ephemeris information) received from a server 140 to determine a location for mobile device 100 or may transfer the measurements to the server 140 to perform the same determination.

While FIG. 1 illustrates mobile device 100 as a smartphone, the mobile device 100 may be any portable device that is capable of receiving location related measurements. A mobile device (e.g. mobile device 100 in FIG. 1) may be referred to as a device, a wireless device, a mobile terminal, a terminal, a mobile station (MS), a user equipment (UE), a SUPL Enabled Terminal (SET) or by some other name and may correspond to a cellphone, smartphone, laptop, tablet, PDA, tracking device, fitness tracker, activity tracker, or some other portable or moveable device. Typically, though not necessarily, a mobile device may support wireless communications such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., mobile device 100) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level). Alternatively, a location of a mobile device may be expressed as a civic location (e.g., as a postal address or the designation of some point or small area in a building such as a particular room or floor). A location of a mobile device may also be expressed as an area or volume (defined either geographically or in civic form) within which the mobile device is expected to be located with some probability or confidence level (e.g., 67% or 95%). A location of a mobile device may further be a relative location comprising, for example, a distance and direction or relative X, Y (and Z) coordinates defined relative to some origin at a known location which may be defined geographically or in civic terms or by reference to a point, area or volume indicated on a map, floor plan or building plan. In the description contained herein, the use of the term location may comprise any of these variants unless indicated otherwise.

During the initiation of a new SPS session, the position uncertainty and time uncertainty of the mobile device 100 may be used to limit the search window for acquiring signals from SPS satellites 120. The position uncertainty of the mobile device 100 increases if the position of the mobile device 100 has not been determined for an extended period of time or if the mobile device 100 has moved a significant distance since the last position fix. During SPS signal acquisition, however, often the time uncertainty is a more dominant parameter than position uncertainty. The time uncertainty is the uncertainty of the time with respect to the clock used by the SPS system. Accordingly, to reduce or minimize the search window for acquiring SPS signals, it is desirable for the mobile device 100 to use a highly accurate clock.

To avoid the cost and power consumption of a highly accurate on-board clock, the mobile device 100 may use a clock signal received from a wireless communication transmitter, such as the base station 110. If desired, the clock signal may be received from an access point, although access points tend to have a higher clock error rate than base stations. The clock signal provided by the wireless communication transmitter, e.g., base station 110 which is part of a cellular network, may be initialized using a time signal as obtained from the SPS system. For example, during an SPS session, the mobile device 100 may acquire and decode the SPS signal 122 provided by the SPS satellites 120. The signal 122 broadcast by the SPS satellite 120 may include, for example, an encoded message frame comprising time data representing the current SPS date and time at the start of the message, as well as other information that may be used to identify the satellite and its location. The decoded SPS time has a low uncertainty (error), e.g., a few nanoseconds, but it is not a continuous clock and is therefore only valid for the moment that the satellite signals are received. The decoded SPS time is used to initialize a clock on the mobile device 100, which may be maintained using a wirelessly received clock signal from the wireless communication transmitter 110 or 115. The decoded SPS time that is maintained using a clock signal from a wireless communication transmitter is sometimes referred to herein as global time.

Even with the use of a clock signal from wireless communication transmitter to maintain the global time on the mobile device 100, there is still a considerable time uncertainty. For example, the mobile device 100 and the wireless communication transmitter are typically not at the same position and accordingly there will be a time delay for the clock signal from the wireless communication transmitter to reach the mobile device 100. Moreover, if the location of the wireless communication transmitter is unknown to the mobile device 100, the distance between the mobile device 100 and the wireless communication transmitter will be unknown. Accordingly, the amount of time delay for the clock signal from the wireless communication transmitter to reach the mobile device 100 is also unknown and is, therefore, a source of time uncertainty. One way to estimate the time uncertainty due to the delay in the propagation of the signal from the wireless communication transmitter to the mobile device 100 is to use a worst case propagation delay. The worst case propagation delay may be based on the maximum antenna range (MAR) of the wireless communication transmitter, which for base stations 110 may be equivalent to, e.g., 20 μs to 100 μs in propagation delay. The actual MAR or propagation delay may be specific to the wireless communication transmitter. The use of a worst case propagation delay, however, may result in a large time uncertainty. The time uncertainty, however, affects the search window for acquiring signals from SPS satellites. To enable quicker SPS sessions with lower power usage, the search space used during satellite acquisition should be reduced or minimized. Accordingly, it is desirable to reduce the time uncertainty to less than the worst case propagation delay, which will reduce the search window, thereby reducing power consumption of the mobile device.

To reduce the time uncertainty, mobile device 100 may determine the time uncertainty based on a relative change in position with respect to the last position fix, which may be referred to as a reference position or base position. For example, a position fix determined from signals 122 received from SPS satellites 120 may be used as the base position, and the relative change in position may be determined with respect to the base position. For example, the relative change in position may be determined using inertial sensors or other motion sensors. Alternatively, the relative change in position may be determined by comparing the base position to a current position as determined from measurements from wireless communication transmitters, such as base station 110 or access point 115. The time uncertainty may be determined by converting the relative change in position with respect to the position fix to time units based on the speed of the signals received from the wireless communication transmitter, i.e., the speed of light. The time uncertainty may be continuously or periodically updated based on relative change in position of the mobile device 100. Accordingly, when the mobile device 100 enters a subsequent SPS session, the search window for satellites may be reduced using the updated time uncertainty. Moreover, the position fix from the subsequent SPS may be used to reset the base position and the SPS time, including the time uncertainty and the process may repeat.

By avoiding the use of a worst case propagation delay as the time uncertainty and instead using a time uncertainty based on a relative change in position with respect to the last position fix, the initial time uncertainty for the global time may be reduced by up to 90%. Additionally, subsequent single SPS session times may be reduced resulting in up to 66% less power consumption.

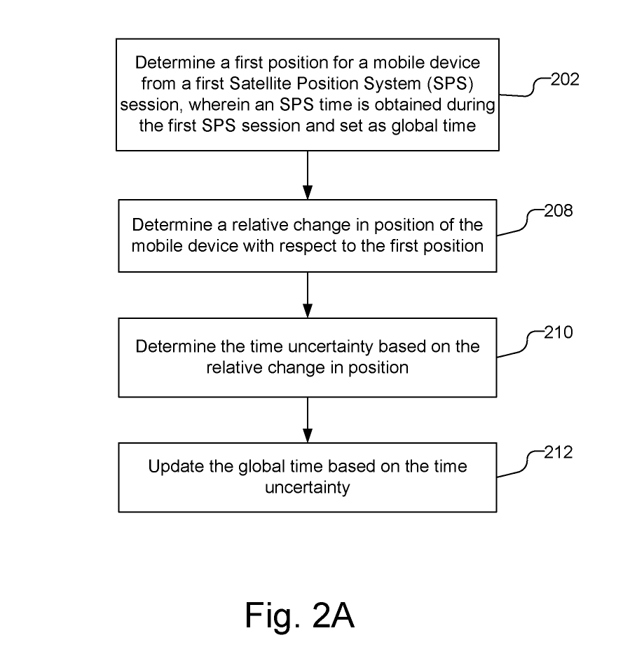

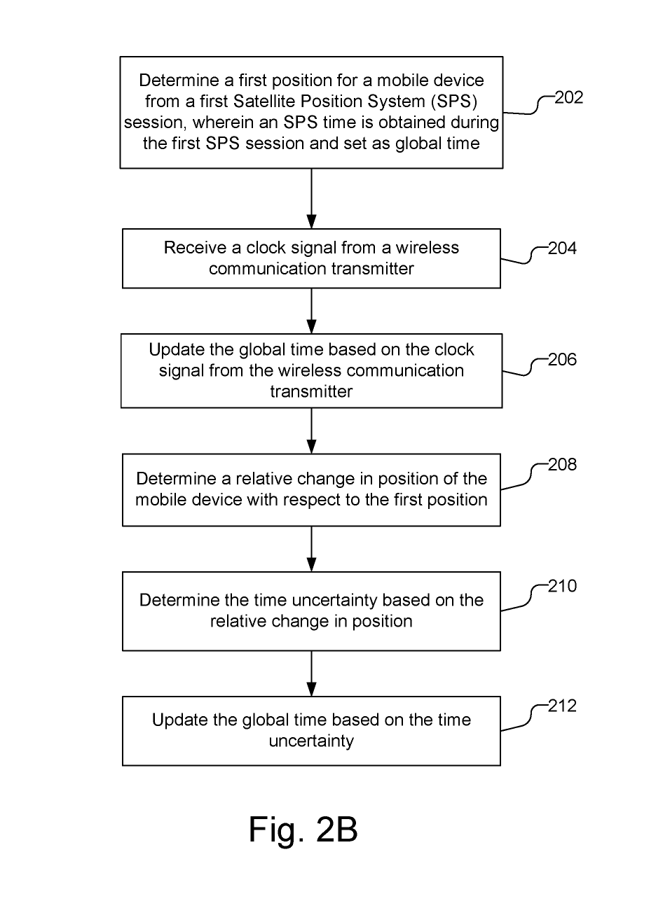

FIGS. 2A and 2B are flow charts illustrating a method of determining time uncertainty based on a relative change in position. As illustrated in FIG. 2A, a first position is determined for a mobile device from a first Satellite Position System (SPS) session, wherein an SPS time is obtained during the first SPS session and set as global time on the mobile device (202). The SPS time, for example, may be decoded from the received SPS signal. The first position serves as a reference position, sometimes referred to herein as a base position.

A relative change in position of the mobile device is determined with respect to the base position (208). The relative change in position may be determined based on data from inertial sensors in the mobile device. The relative change in position may be determined as a distance traveled by the mobile device from the base position, i.e., the total distance traveled. The total distance traveled may be determined, e.g., using inertial sensors, such as accelerometers. In another implementation, the relative change in position may be a magnitude of the displacement of the mobile device with respect to the base position, i.e., the distance along a straight line from the base position to a current position of the mobile device. The displacement of the mobile device with respect to the base position may be determined as the distance and direction between the base position and a current position. The current position may be determined, e.g., using inertial sensors, such as accelerometers, gyroscopes, electronic compass, etc., using dead reckoning. It should be understood that minor motion of the mobile device, such as when a user moves the mobile device to check the display, may be detected, e.g., when it is below a designated threshold, and ignored as it does not contribute to the relative change in position of the mobile device. Additionally, it should be understood that position uncertainty that may accumulate during dead reckoning may be included in the relative change in position of the mobile device, i.e., the worst case relative change in position may be used.

In other embodiments, the relative change in position may be determined based on a current position as determined using other sensors in the mobile device, such as cameras performing vision based positioning. In another embodiment, wireless transceivers may be used to make location related measurements of wireless signals, e.g., RTT or RSSI, from wireless communication transmitter, such as base station 110 or access point 115 shown in FIG. 1. The current position of the mobile device may be determined by the mobile device 100 or a remote server 140 using the location related measurements and known positions from a number of wireless communication transmitters, e.g., through multilateration.

The time uncertainty is determined based on the relative change in position (210). For example, the time uncertainty may be determined by converting the relative change in position into time units, e.g., by dividing the relative change in position by the speed of light (the speed of the clock signal from the wireless communication transmitter). In some embodiments, the conversion of the relative change in position to time units may be based on a data in a look-up table or may be otherwise hard coded. The time uncertainty may include additional uncertainty components as well. For example, the time uncertainty may additionally be based on an initial time uncertainty that results from the global time being updated based on the clock signal from the wireless communication transmitter. Additionally, if the mobile device is in motion while the base position is being determined and set, an additional time uncertainty may be added, e.g., because the initial position association with wireless communication transmitter clock may have a jitter, which should be contained in the time uncertainty.

The global time is updated based on the time uncertainty (212). The determination of the time uncertainty and update of the global time with the time uncertainty may be periodically or continuously performed, e.g., using continuous input of data from the inertial sensors as the mobile device changes position with respect to the base position. For example, the global time may be iteratively updated, which may include determining a second relative change in position of the mobile device with respect to the first position, determining a second time uncertainty based on the second relative change in position, and updating the global time based on the second time uncertainty. The second relative change in position of the mobile device with respect to the first position may be based on a second current position that is determined as discussed above.

The time uncertainty may then be used by the mobile device in a desired application. For example, in one implementation, the mobile device may enter a second SPS session, in which a search for satellites is performed using a search window based on the updated global time, e.g., the global time after being updated based on the time uncertainty and in some implementations, the clock signal from the wireless communication transmitter. The mobile device may use the time uncertainty in other applications, such as applications that use SPS time based synchronization methods. For example, device to device communication over WLAN may require SPS time and time uncertainty in order to properly synchronize.

FIG. 2B is a flow chart, similar to FIG. 2A, like designated elements being the same. As illustrated in FIG. 2B, the method may further include receiving a clock signal from a wireless communication transmitter (204). The wireless communication transmitter may be a base station, e.g., that is part of a wide area network, such as a GSM, WCDMA, TDSCDMA or LTE network, or may be an access point, including, e.g., router, a bridge, a femtocell or microcell. The global time is updated based on the clock signal from the wireless communication transmitter (206). It should be understood that the updating of the global time based on the clock signal is not necessarily a one-time update. Instead the global time may be continuously updated based on the clock signal.

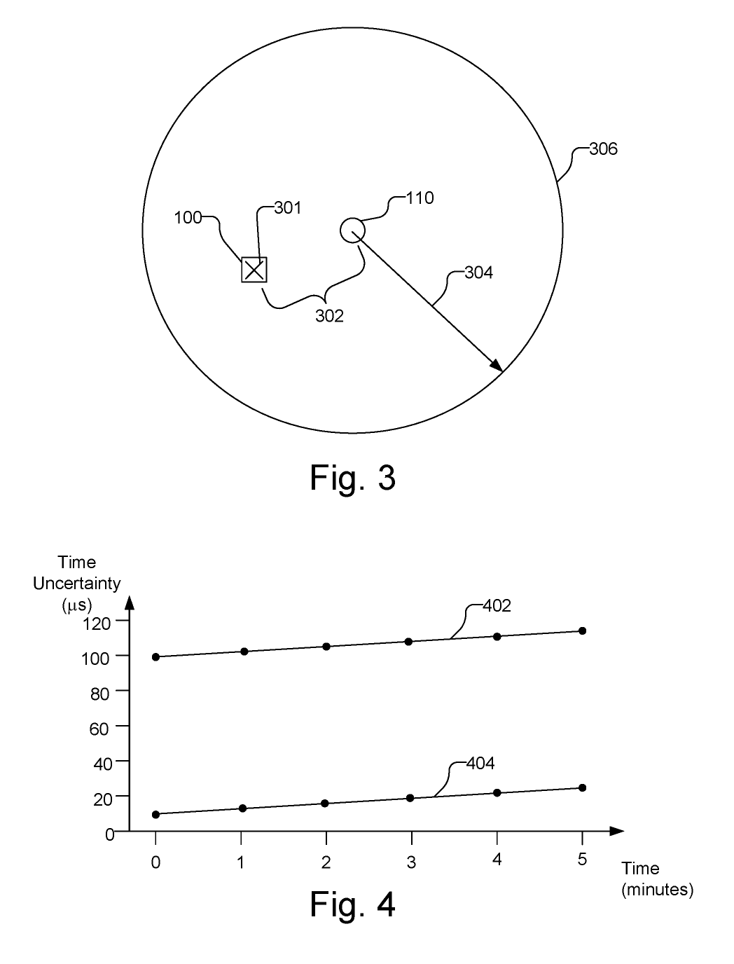

FIGS. 3 and 4 provide illustrations of an example implementation, in which the mobile device 100 is static, i.e., there is no relative change in position. FIG. 3 illustrates the base position 301 of the mobile device 100 as determined from an SPS session and illustrates the base station 110. The position of the base station 110 may be unknown and, consequently, the distance 302 between the mobile device 100 and the base station 110 may be unknown. The base station 110 has a maximum antenna range 304 that defines a cellular coverage area 306 illustrated by circle in which the mobile device 100 is located. FIG. 4 is a graph illustrating the growth of time uncertainty, with the Y axis representing the time uncertainty in s and the X axis representing elapsed time in minutes. In the static example illustrated in FIGS. 3 and 4, the mobile device 100 does not change position with respect to the base position 301. The base station 110 may be assumed to have a worst case propagation delay of 100 μs due to the maximum antenna range (MAR) 304. The time uncertainty may be assumed to increase due to the use of a clock signal from the base station 110 at 3 μs/minute, e.g., the base station 110 is synchronized with SPS time at 50 ppb.

FIG. 4 illustrates the growth of time uncertainty over 5 minutes from the position fix at time 0. Curve 402 in FIG. 4 illustrates the time uncertainty growth if the time uncertainty is based on the worst case propagation delay due to the maximum antenna range (MAR) 304 of the base station 110. As illustrated, the time uncertainty is initially set at time 0 at 100 μs (the worst case propagation delay), and increases at 3 μs/minute. After 5 minutes, the time uncertainty is 115 μs (=100 μs (MAR)+15 μs (5 min*3 μs/min)). Thus, assuming the search window size for an SPS engine may have a maximum uncertainty of 60 μs; two full searches will be required to acquire satellite signals in a new SPS session if the time uncertainty is based on the worst case propagation delay.

Curve 404 in FIG. 4 illustrates the growth of time uncertainty over 5 minutes if the time uncertainty is based on the relative change in position of the mobile device 100 with respect to the base position 301. As illustrated, the time uncertainty is initially set at 10 μs. The initial time uncertainty may be set due to the alignment of different clocks. For example, the global time is initialized with the SPS clock at an uncompensated reference time T1. The alignment of the global time with the base station clock signal happens at uncompensated reference time T2. Thus, to align the SPS clock with base station clock, an uncompensated clock is used between times T1 and T2, which may cause additional time uncertainty of up to 10 μs. The inherent uncertainty in switching between the clocks may be 1-10 μs, and the larger possible time uncertainty is used in the present example. In the present example, the mobile device 100 is static, i.e., there is no relative change in position with respect to the base position 301, but the time uncertainty is assumed to increase at 3 μs/minute, due to the base station 110 being synchronized with SPS time at 50 ppb. Accordingly, after 5 minutes, the time uncertainty is 25 μs (=10 μs (initial)+15 μs (5 min*3 μs/min)). With a maximum uncertainty of the search window assumed to be 60 μs, as above, only one search cycle will be required to acquire satellite signals in a new SPS session if the time uncertainty is based on the relative change in position of the mobile device 100 with respect to the base position 301. Thus, use of the relative change in position for the time uncertainty instead of the worst case propagation delay represents a 50% power saving.

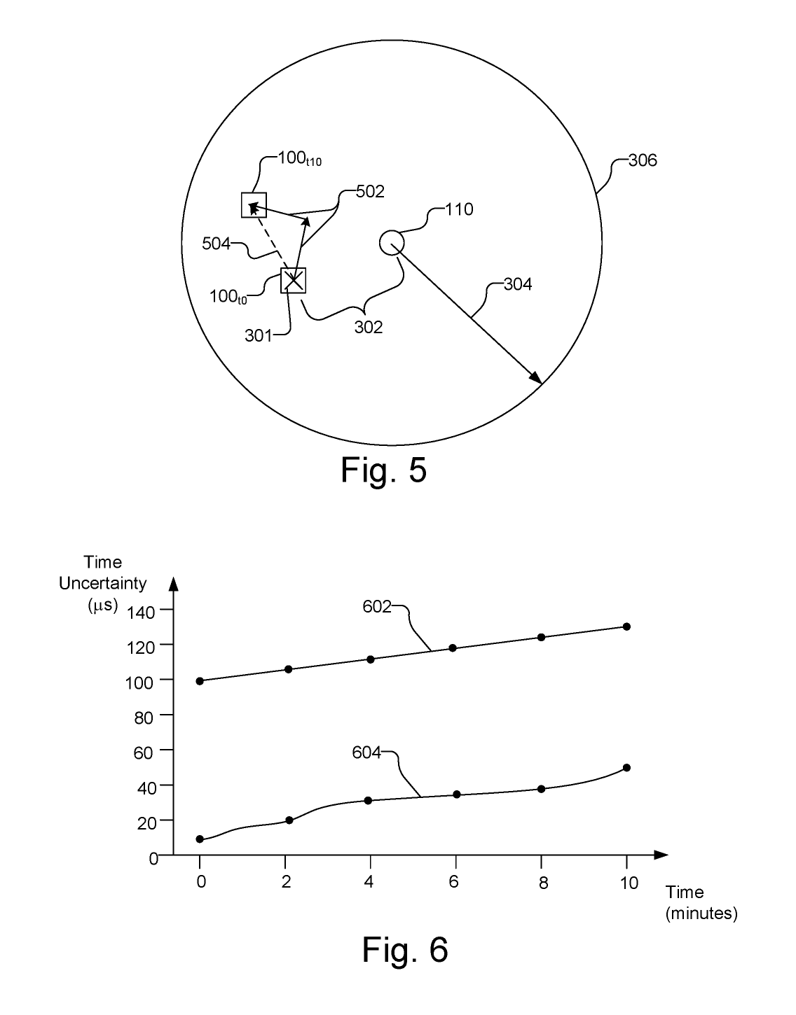

FIGS. 5 and 6 are similar to FIGS. 3 and 4, discussed above, like designated elements being the same. FIGS. 5 and 6, however, illustrate an example implementation in which the mobile device 100 is dynamic, i.e., there is a position change of the mobile device 100 relative to the base position 301 determined in a first SPS session. As with the above example, the position of the base station 110 may be unknown and, thus, the distance 302 between the base station 110 and the mobile device 100 at the base position 301 may be unknown. As in the above example, the base station 110 may be assumed to have a worst case propagation delay of 100 μs due to the maximum antenna range (MAR) 304 and the time uncertainty may be assumed to increase at 3 μs/minute the base station 110 is synchronized with SPS time at 50 ppb.

FIG. 5 illustrates the relative change in position of the mobile device 100 by illustrating the position of the mobile device 100 at time 0 with the designation 100ₜ₀ and illustrating the position of the mobile device 100 at time 10 minutes with the designation 100ₜ₁₀. The actual path traveled by the mobile device 100 is illustrated with solid arrows 502 in FIG. 5, while the resulting displacement (distance and direction) between the base position 301 and the position 100ₜ₁₀ of the mobile device 100 at time 10 is illustrated with a dotted arrow 504. The relative change in position of the mobile device 100 with respect to the base position 301 may be determined based on the distance traveled, e.g., along arrows 502, which may be determined using inertial sensors, such as accelerometers. In this implementation, the direction of travel is not needed and, accordingly, data from gyroscopes, compasses, etc. is not used. Alternatively, the distance traveled may be determined based on the distance between a series of position updates as the mobile device 100 travels along path 502. The relative change in position of the mobile device 100 with respect to the base position 301 may also be determined as a magnitude of the displacement (distance) between a current position e.g., shown at 100ₜ₁₀ and the base position 301, illustrated by arrow 504. The current position may be determined using inertial sensors, such as accelerometers, gyroscopes, electronic compass, etc., based on dead reckoning. The current position may alternatively be determined using location based measurements of wireless signals from wireless communication transmitters, e.g., base stations, access points, femtocells, picocells, microcells, or a combination thereof.

FIG. 6 illustrates the growth of time uncertainty over 10 minutes from the position fix at time 0. Curve 602 in FIG. 6 illustrates the time uncertainty growth if the time uncertainty is based on the worst case propagation delay due to the maximum antenna range (MAR) 304 of the base station 110. As with the static example, the time uncertainty is initially set at 100 μs (the worst case propagation delay), and increases at 3 μs/minute. The movement of the mobile device 100 within the cellular coverage area 306 does not affect the time uncertainty growth illustrated by curve 602. Accordingly, after 10 minutes, the time uncertainty is 130 μs (=100 μs (MAR)+30 μs (10 min*31 μs/min)). Thus, assuming the search window size for an SPS engine may have a maximum uncertainty of 60 μs, three full searches will be required after 10 minutes to acquire satellite signals in a new SPS session if the time uncertainty is based on the worst case propagation delay

Curve 604 in FIG. 6 illustrates the growth of time uncertainty over 10 minutes if the time uncertainty is based on the relative change in position of the mobile device 100 with respect to the base position 301. As with the static example, the time uncertainty may be initially set at 10 μs, due to switching between the SPS clock and the base station clock, and the time uncertainty is assumed to increase at 3 μs/minute, due to the base station 110 being synchronized with SPS time at 50 ppb. Additionally, the time uncertainty increases based on the relative change in position of the mobile device 100 with respect to the base position 301.

The relative change in position may be transformed into time units by dividing the relative change in position by the speed of the clock signal from the base station 110, i.e., the speed of light. In the present example, assuming the relative change in position of the mobile device 100 at 10 minutes is 1.6 miles (i.e., either the total distance traveled along path 502 or the magnitude of the displacement along 504), and the time uncertainty increases at 3 μs/minute, after 10 minutes the total uncertainty is 50 μs (=10 μs (initial)+30 μs (10 min*3 μs/min)+10 μs (=1.6 mile/c)). With a maximum uncertainty of the search window assumed to be 60 μs, as above, only one search cycle will be required to acquire satellite signals in a new SPS session if the time uncertainty is based on the relative change in position of the mobile device 100 with respect to the base position 301. Thus, use of the relative change in position for the time uncertainty instead of the worst case propagation delay represents a 66% power saving.

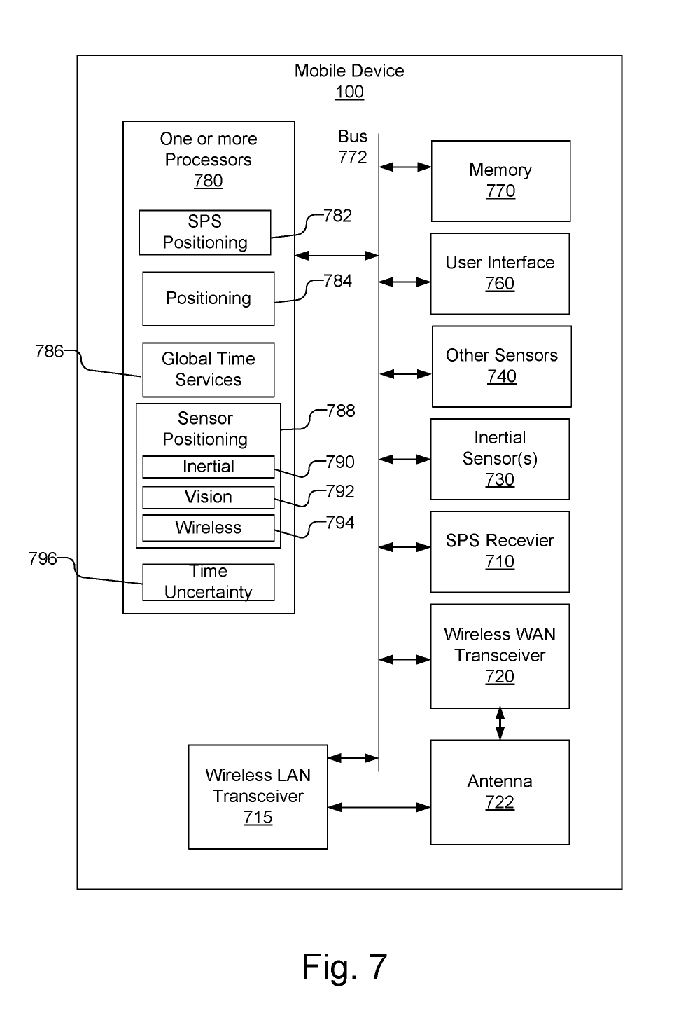

FIG. 7 is a block diagram of the mobile device 100 capable of determining a time uncertainty as discussed herein. The mobile device 100 includes an SPS receiver 710 with which SPS signals from an SPS system may be received. The mobile device 100 may include a wireless wide area network (WWAN) transceiver 720 to wirelessly communicate with base stations 110 (shown in FIG. 1). The mobile device 100 may also include a wireless local area network (WLAN) transceiver 715 to wirelessly communicate with access points, such as access point 115 shown in FIG. 1. The mobile device 100 may receiver clock signals from a wireless communication transmitter using e.g., the WWAN transceiver 720 or the WLAN transceiver 715.

The mobile device may further include inertial sensors 730, such as accelerometers, gyroscopes, or other similar sensors such as an electronic compass, magnetometer, etc. that produce data with which relative change in position may be determined. The mobile device may include other types of motion sensors 740 including, e.g., cameras, that can also produce data with which relative changes in position may be determined. Additionally, the wireless signals received by WLAN transceiver 715 or WWAN transceiver 720 may also be used to determine relative changes in position as discussed above. The mobile device 100 may include one or more antennas 722 that may be used with the WWAN transceiver 720 and WLAN transceiver 715.

The mobile device 100 may further include a user interface 760 that may include e.g., a display, a keypad or other input device, such as virtual keypad on the display, through which a user may interface with the mobile device 100.

The mobile device 100 further includes a memory 770 and one or more processors 780, which may be coupled together with bus 772. The one or more processors 780 and other components of the mobile device 100 may similarly be coupled together with bus 772, a separate bus, or may be directly connected together or a combination of the foregoing. The memory 770 may contain executable code or software instructions that when executed by the one or more processors 780 cause the one or more processors to operate as a special purpose computer programmed to perform the algorithms disclosed herein.

As illustrated in FIG. 7, the one or more processors 780 may include one or more processing units or components that implement the methodologies as described herein. For example, the one or more processors 780 may include an SPS positioning engine 782 that may determine a position fix from the SPS signals received by the SPS receiver 710. The SPS positioning engine 782 may additionally decode the SPS signal to obtain the SPS time which is set as the global time in the global time services engine 786.

The one or more processors 780 may further include a positioning engine 784 that may determine the relative changes in position. For example, positioning engine 784 may set a position fix from the SPS positioning engine 782 as a base position and may determine relative changes in position with respect to the base position. As discussed above, the positioning engine 784 may determine the relative change in position based on distance traveled from the base position or as the magnitude of the displacement between a current position and the base position.

The one or more processors 780 includes a global time services engine 786 that sets the global time based on the decoded SPS time and is maintained using the clock signal received from the wireless communication transmitter by, e.g., the WWAN transceiver 720 or WLAN transceiver 715. The global time services engine 786 may further set the initial time uncertainty when the global time is set and update the time uncertainty as determined by the time uncertainty engine 796. The global time services engine 786 is illustrated as separate from SPS positioning engine 782 for clarity, but, it should be understood that the global time services engine 786 may be part of the SPS positioning engine 782.

The one or more processors 780 may further include a sensor positioning engine 788, which may receive data from one or more sensors and determine a current position of the mobile device 100. For example, the sensor positioning engine 788 may include an inertial positioning engine 790 that may receive data from inertial sensors 730 and determine a current position, e.g., using dead reckoning, or a vision based positioning engine 792 that may receive data from other a camera and determine a current position, e.g., using vision based positioning. The sensor positioning engine 788 may include a wireless positioning engine 794 that may location based measurements, e.g., RSSI or RTT, from WWAN transceiver 720 or WLAN transceiver 715 and determine a current position from the location based measurements and known positions of the transmitters, e.g., using multilateration or other known techniques, or may communicate with a remote server 140 (shown in FIG. 1), using WWAN transceiver 720 or WLAN transceiver 715, to determine the position of the mobile device 100 based on the signals received from the WWAN transceiver 720 or WLAN transceiver 715. The current position or distanced traveled as determined by the sensor positioning engine 788 may be used by the positioning engine 784 to determine the relative change in position from the base position.

The one or more processors 780 may include a time uncertainty engine 796 to determine the time uncertainty based on the relative change in position from the base position, as determined, e.g., by the positioning engine 784. For example, the time uncertainty engine 796 may transform the relative change in position into time units by dividing the relative change in position by the speed of the clock signal from the base station 110, i.e., the speed of light. The determined time uncertainty may be used to update the global time by the global time services engine 786.

The methodologies described herein may be implemented by various means depending upon the application. For example, these methodologies may be implemented in hardware, firmware, software, or any combination thereof. For a hardware implementation, the one or more processors may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For an implementation involving firmware and/or software, the methodologies may be implemented with modules (e.g., procedures, functions, and so on) that perform the separate functions described herein. Any machine-readable medium tangibly embodying instructions may be used in implementing the methodologies described herein. For example, software codes may be stored in a memory and executed by one or more processor units, causing the processor units to operate as a special purpose computer programmed to perform the algorithms disclosed herein. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a non-transitory computer-readable storage medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage, semiconductor storage, or other storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer-readable storage medium, instructions and/or data may be provided as signals on transmission media included in a communication apparatus. For example, a communication apparatus may include a transceiver having signals indicative of instructions and data. The instructions and data are stored on non-transitory computer readable media, e.g., memory 770, and are configured to cause the one or more processors to operate as a special purpose computer programmed to perform the algorithms disclosed herein. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

The mobile device 100 includes a means for determining a first position for the mobile device from a first Satellite Position System (SPS) session, wherein an SPS time is obtained during the first SPS session and set as global time, which may include, e.g., the SPS receiver 710, an SPS positioning engine 782 and the global time services engine 786. A means for determining a relative change in position of the mobile device with respect to the first position may include, e.g., inertial sensors 730, sensors 740, WWAN transceiver 720, WLAN transceiver 715, the sensor positioning engine 788, which may include the inertial, visual, or wireless positioning engines, and the positioning engine 784. A means for determining the time uncertainty based on the relative change in position may include, e.g., the time uncertainty engine 796. A means for updating the global time based on the time uncertainty may include, e.g., the global time services engine 786.

The mobile device 100 may further include a means for receiving a clock signal from a wireless communication transmitter may include, e.g., a WWAN transceiver 720 or WLAN transceiver 715, and a means for updating the global time based on the clock signal from the b wireless communication transmitter may include, e.g., the global time services engine 786.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method of determining a time uncertainty, the method comprising:
determining a first position for a mobile device from a first Satellite Position System (SPS) session, wherein an SPS time is obtained during the first SPS session and set as global time;
determining a relative change in position of the mobile device with respect to the first position;
determining the time uncertainty based on the relative change in position; and
updating the global time based on the time uncertainty.

2. The method of claim 1, wherein the relative change in position is determined based on data from one or more inertial sensors in the mobile device.

3. The method of claim 1, wherein the relative change in position is a distance traveled by the mobile device from the first position.

4. The method of claim 1, wherein the relative change in position is a magnitude of a displacement of the mobile device with respect to the first position.

5. The method of claim 1, further comprising:
receiving a clock signal from a wireless communication transmitter; and
updating the global time based on the clock signal from the wireless communication transmitter.

6. The method of claim 5, wherein the time uncertainty is further determined based on an initial time uncertainty resulting from updating the global time based on the clock signal from the wireless communication transmitter.

7. The method of claim 5, wherein the wireless communication transmitter is a base station or an access point.

8. The method of claim 1, wherein the time uncertainty is determined by converting the relative change in position into time units.

9. The method of claim 1, further comprising iteratively updating the global time comprising:
determining a second relative change in position of the mobile device with respect to the first position;
determining a second time uncertainty based on the second relative change in position; and
updating the global time based on the second time uncertainty.

10. The method of claim 1, further comprising entering a second SPS session comprising performing a search for satellites using a search window based on the updated global time.

11. A mobile device for determining a time uncertainty, the mobile device comprising:
a Satellite Position System (SPS) receiver configured to receive signals from satellites in an SPS system;
at least one inertial sensor; and
at least one processor coupled to the SPS receiver and the at least one inertial sensor, the at least one processor configured to determine a first position for the mobile device from received signals from satellites during a first SPS session, wherein an SPS time is obtained during the first SPS session and set as a global time; determine a relative change in position of the mobile device with respect to the first position based on signals from the at least one inertial sensor; determine the time uncertainty based on the relative change in position; and update the global time based on the time uncertainty.

12. The mobile device of claim 11, wherein the relative change in position is a distance traveled by the mobile device from the first position.

13. The mobile device of claim 11, wherein the relative change in position is a magnitude of a displacement of the mobile device with respect to the first position.

14. The mobile device of claim 11, wherein the mobile device further comprises a wireless transceiver configured to receive a clock signal from a wireless communication transmitter, the at least one processor being coupled to the wireless transceiver, the at least one processor being further configured to update the global time based on the clock signal received from the wireless communication transmitter.

15. The mobile device of claim 14, wherein the time uncertainty is further determined based on an initial time uncertainty resulting from updating the global time based on the clock signal from the wireless communication transmitter.

16. The mobile device of claim 14, wherein the wireless communication transmitter is a base station or an access point.

17. The mobile device of claim 11, wherein the at least one processor is configured to determine the time uncertainty by being configured to convert the relative change in position into time units.

18. The mobile device of claim 11, wherein the at least one processor is configured to iteratively update the global time by being configured to determine a second relative change in position of the mobile device with respect to the first position based on the signals from the at least one inertial sensor; determine a second time uncertainty based on the second relative change in position; and update the global time based on the second time uncertainty.

19. The mobile device of claim 11, wherein the at least one processor is further configured to enter a second SPS session by causing the SPS receiver to perform a search for satellites using a search window based on the updated global time.

20. A mobile device for determining a time uncertainty, the mobile device comprising:
means for determining a first position for the mobile device from a first Satellite Position System (SPS) session, wherein an SPS time is obtained during the first SPS session and set as global time;
means for determining a relative change in position of the mobile device with respect to the first position;
means for determining the time uncertainty based on the relative change in position; and
means for updating the global time based on the time uncertainty.

21. The mobile device of claim 20, wherein the means for determining the relative change in position comprises inertial sensors in the mobile device.

22. The mobile device of claim 20, wherein the relative change in position is a distance traveled by the mobile device from the first position.

23. The mobile device of claim 20, wherein the relative change in position is a magnitude of a displacement of the mobile device with respect to the first position.

24. The mobile device of claim 20, further comprising:
means for receiving a clock signal from a wireless communication transmitter; and
means for updating the global time based on the clock signal from the wireless communication transmitter.

25. The mobile device of claim 24, wherein the time uncertainty determined by the means for determining the time uncertainty is further based on an initial time uncertainty resulting from updating the global time based on the clock signal from the wireless communication transmitter.

26. A non-transitory computer-readable medium for determining a time uncertainty, the non-transitory computer-readable medium including program code stored thereon, comprising:
program code to determine a first position for a mobile device from a first Satellite Position System (SPS) session, wherein an SPS time is obtained during the first SPS session and set as global time;
program code to determine a relative change in position of the mobile device with respect to the first position;
program code to determine the time uncertainty based on the relative change in position; and
program code to update the global time based on the time uncertainty.

27. The non-transitory computer-readable medium of claim 26, wherein the relative change in position is a distance traveled by the mobile device from the first position.

28. The non-transitory computer-readable medium of claim 26, wherein the relative change in position is a magnitude of a displacement of the mobile device with respect to the first position.

29. The non-transitory computer-readable medium of claim 26, further comprising;
program code to receive a clock signal from a wireless communication transmitter;
program code to update the global time based on the clock signal from the wireless communication transmitter.

30. The non-transitory computer-readable medium of claim 29, wherein the time uncertainty is further based on an initial time uncertainty resulting from updating the global time based on the clock signal from the wireless communication transmitter.
